(19) United States
(12) Patent Application Publication
(10) Pub. No.: US 2003/0010774 A1
(43) Pub. Date: Jan. 16, 2003

(54) Thermoconductive rubber patch

(75) Inventor: Sheng-Chung Yang, Nan Tou City (TW)

Correspondence Address: Harrison & Egbert, 7th Floor, 412 Main St., Houston, TX, 77002, US

(73) Assignee: Chi Wei Victory Co., Ltd.

(21) Appl. No.: 09/902,978

(22) Filed: Jul. 11, 2001

(51) Int. Cl. H05B 3/34

(52) U.S. Cl. 219/549; 219/553; 219/543

(57) ABSTRACT

A thermoconductive rubber patch comprises a thermoconductive rubber piece which is encased by an insulating casing and is made of rubber, carbon black granules and metal granules. The thermoconductive rubber piece is provided with an electric circuit and is capable of generating heat at the time when an electric current flows over the electric circuit. The thermoconductive rubber piece has a resistance, with the magnitude of the resistance being dependent on a ratio by which the carbon black granules and the metal granules are contained in the thermoconductive rubber piece.

### BACKGROUND OF THE INVENTION

1. Field of the Invention

The present invention relates generally to a thermoconductive rubber material, and more particularly to a thermoconductive rubber patch capable of providing and keeping heat.

2. Description of Related Art

The conventional heating devices are not always suitable for use in a variety of situations. For example, a space heater is designed for use in warning the air of a single confined area. However, the space heater is not suitable for use in the outdoors. In fact, there is currently lack of a material which is capable of providing and keeping heat and can be easily carried around or stored without taking up too much of space.

### BRIEF SUMMARY OF THE INVENTION

The primary objective of the present invention is to provide a thermoconductive rubber patch capable of providing and keeping heat.

In keeping with the principle of the present invention, the foregoing objective of the present invention is attained by the thermoconductive rubber patch comprising an insulating casing, and a thermoconductive rubber piece which is encased by the insulating casing and is made of rubber, carbon black granules, and metal granules. The thermoconductive rubber piece is provided with an electric circuit over which an electric current flows. The thermoconductive rubber piece serves as a resistance to bring about the generation of heat.

The features and functions of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows an exploded view of the preferred embodiment of the present invention.

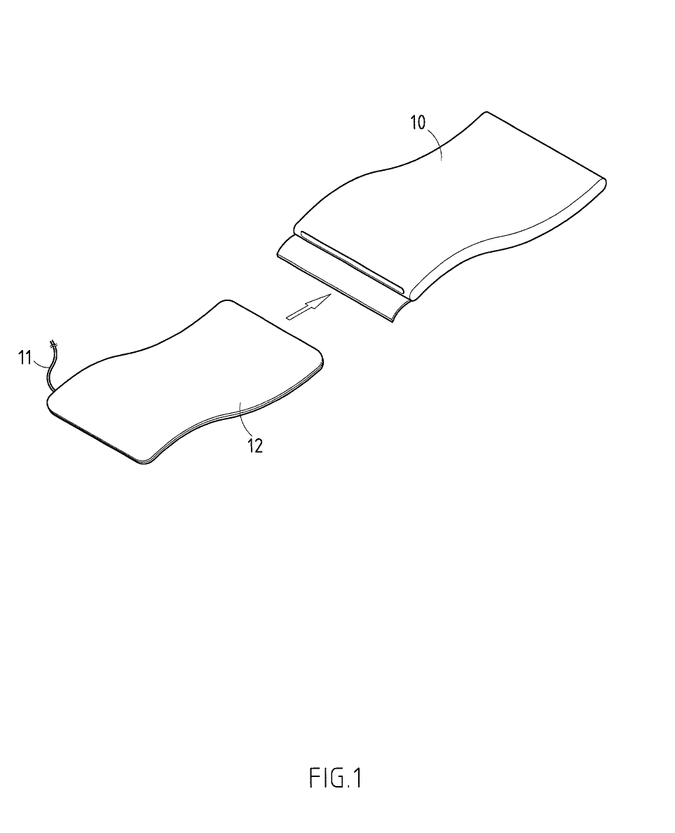

FIGS. 2a, 28 and 2C are schematic views showing that three thermoconductive rubber pieces of the preferred embodiments of the present invention vary in terms of ratio of carbon black and metal.

FIG. 3 shows a process flow of the preferred embodiment o present invention.

### DETAILED DESCRIPTION OF THE INVENTION

As shown in all drawings provided herewith, a thermoconductive rubber piece of the preferred embodiment of the present invention comprises an insulation casing 10, and a thermoconductive rubber piece 12 which is provided with an electric circuit 11 and is encased by the insulating casing 10. When an electric current flows over the electric circuit 11, the thermoconductive rubber piece 12 acts as a resistance to bring about the generation of heat.

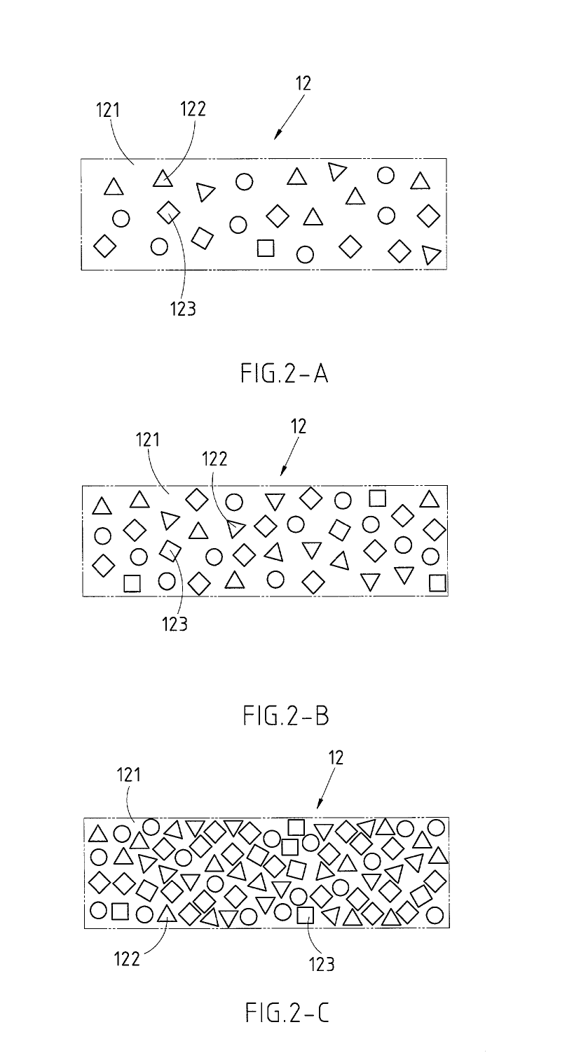

The thermoconductive rubber piece 12 is made of a rubber material 121, a predetermined amount of carbon black granules 122, and a predetermined amount of metal granules 123, as illustrated in FIGS. 2A, 2B, and 2C.

Depending on the amounts of the carbon black granules 122 and the metal granules 123, the resistance of the thermoconductive rubber piece 12 can be changed to result in generation of heat of a desired temperature. For example, a reduction in quantity of the carbon black granules 122 and the metal granules 123 results in a corresponding reduction in resistance of the thermoconductive rubber piece 12. As a result, the heat generated by the thermoconductive rubber piece 12 is reduced. On the other hand, a greater heat is generated by the thermoconductive rubber piece 12 as a result of an increase in quantity of the carbon black granules 122 and the metal granules 123.

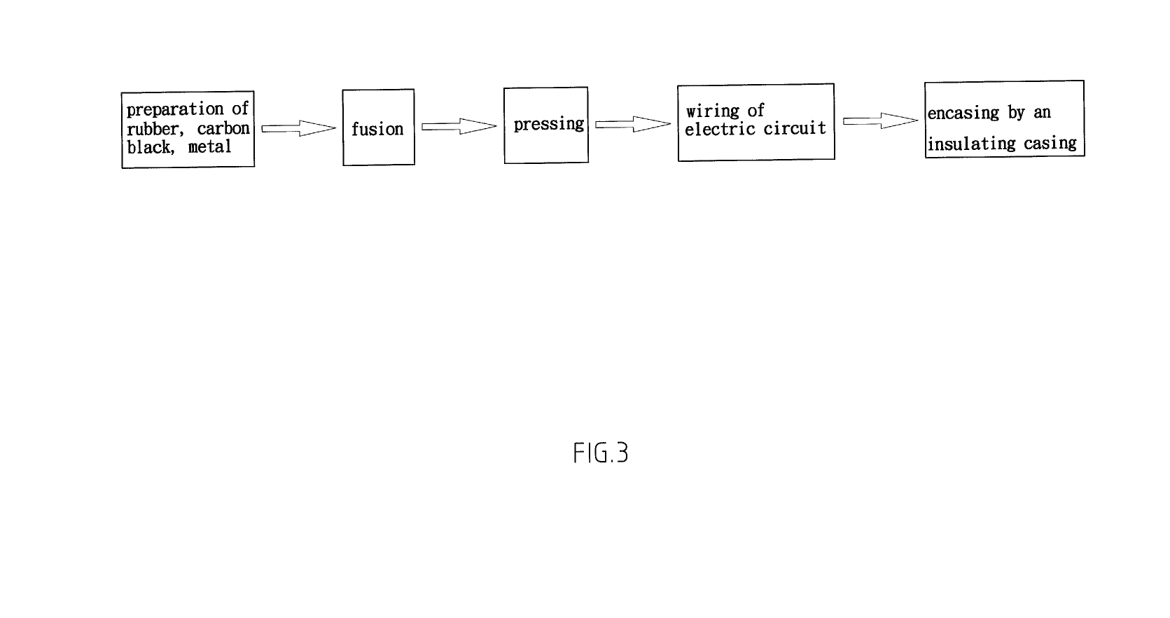

As illustrated in FIG. 3, the manufacturing process of the preferred embodiment of the present invention involves a first step in which the rubber material 121, the carbon black granules 122, and the metal granules 123 are prepared and joined together by fusion. The intermediate product so made is then made to take a specific form by pressing before it is provided with the electric circuit 11, thereby resulting in production of the thermoconductive rubber piece 12. Finally, the thermoconductive rubber piece 12 is encased by the insulating casing 10. The electric circuit 11 can be externally connected with a power source.

The preferred embodiment of the present invention described above is to be regarded in all respects as being merely illustrative and not restrictive. Accordingly, the present invention may be embodied in other specific forms without deviating from the spirit thereof The present invention is therefore to be limited only by the scopes of the following claims.

I claim:

1. A thermoconductive rubber patch comprising:
an insulating casing; and
a thermoconductive rubber piece provided with an electric circuit and encased by said insulating casing whereby said thermoconductive rubber piece has a resistance to bring about generation of heat of a predetermined temperature at the time when an electric current flows over said electric circuit of said thermoconductive rubber piece.

2. The thermoconductive rubber patch as defined in claim 1, wherein said thermoconductive rubber piece is made of a rubber material, a predetermined amount of carbon black granules, and a predetermined amount of metal granules.

3. The thermoconductive rubber patch as defined in claim 2, wherein the magnitude of the resistance of said thermoconductive rubber piece is determined by a ratio by which said carbon black granules and said metal granules are contained in said thermoconductive rubber piece.
